(19) United States
(12) Patent Application Publication
(10) Pub. No.: US 2019/0140994 A1
(43) Pub. Date: May 9, 2019

(54) SYSTEMS AND METHOD CLASSIFYING ONLINE COMMUNICATION NODES BASED ON ELECTRONIC COMMUNICATION DATA USING MACHINE LEARNING

(71) Applicant: Notion AI, Inc., Ann Arbor, MI (US)

(72) Inventors: Lindsay Snider, Ann Arbor, MI (US); Guy Sutter, Ann Arbor, MI (US); Ian Berry, Ann Arbor, MI (US)

(21) Appl. No.: 16/179,017

(22) Filed: Nov. 2, 2018

Related U.S. Application Data
(60) Provisional application No. 62/581,243, filed on Nov. 3, 2017.

(51) Int. Cl. H04L 12/58; G06N 99/00

(52) U.S. Cl. CPC H04L 51/12; G06N 99/005

(57) ABSTRACT

Systems and methods for online user classification and archetype detection within an electronic communications environment includes accessing electronic communication data exchanged between a plurality of online users; processing the electronic communication data by: extracting archetype data features from the electronic communication data; allowing the extracted archetype data features, as input, into a machine learning classification system; identifying, by the machine learning classification system, at least one archetype classification that relates to at least one distinct online user archetype of a plurality of distinct online user archetypes; wherein an electronic communications service: generates an archetype network mapping comprising a plurality of online users each having one or more associated archetype classification labels and that illustrates network connections between each of the plurality of online users; updates the archetype network mapping to associate the at least one archetype classification to the at least one online user.

### CROSS-REFERENCE TO RELATED APPLICATIONS

This application claims the benefit of U.S. Provisional Application No. 62/581,243, filed 3 Nov. 2017, which is incorporated herein in its entirety by this reference.

### TECHNICAL FIELD

The inventions relate generally to the electronic communication processing and electronic communication interfaces, and more specifically to new and useful systems and methods for identifying nodes in an electronic communication environment and implementing beneficial network mappings in the electronic communication processing and electronic communication interfaces fields.

### BACKGROUND

In many modern contexts, electronic mail (email) is an often-utilized means, if not primary means, of communicating electronically. Now that e-mail communications may be composed and transmitted via numerous communication devices (e.g., mobile phones, wearable devices (e.g., watches), virtual assistive devices, etc.) other than desktops, the amount of e-mail communications received by any given recipient on a single day may easily exceed several hundred emails and probably more than one thousand emails per day. The numerous amount of emails received each day coupled with the additional responses made to some of these emails can overwhelm a user's email account or a viewing device displaying the emails. Specifically, the numerous amount of emails may often overwhelm a user's ability to digest important and/or time-sensitive emails. This, in turn, may cause the user to lose productivity, make mistakes, and/or mishandle one or more important matters.

Thus, there is a need in the electronic communication processing and electronic mail interface field to create new and useful systems and methods for improving efficiencies in email and messaging communications, reducing email and messaging communications, and preserving email and messaging computing resources. The embodiments of the present application provide such new and useful systems and methods.

### SUMMARY OF THE INVENTION

An online system that enables intelligent online user archetype classification within an electronic communications environment based on electronic communications data includes an electronic communications server that accesses electronic communication data generated by at least one online user; an electronic communication processing circuit that processes the electronic communication data by: (i) extracting archetype data features from the electronic communication data; (ii) allowing the extracted archetype data features, as input, into a machine learning classification system; (iii) identifying, by the machine learning classification system, at least one archetype classification that relates to at least one distinct online user archetype of a plurality of distinct online user archetypes; wherein the electronic communications server: generates an archetype network mapping comprising a plurality of online users each having one or more associated archetype classification labels and that illustrates network connections between each of the plurality of online users; updates the archetype network mapping to associate the at least one archetype classification to the at least one online user.

In one embodiment, the archetype classification relates to a predetermined model that represents a type of online user and/or communication node operating in an electronic communication environment.

In one embodiment, the electronic communication processing circuit implements an archetype feature extractor comprising one or more of a deep machine learning model and an archetype data feature filter that operate to assess the electronic communication data of the at least one user and produce a feature corpus comprising the archetype data features.

In one embodiment, the machine learning classification system comprises an ensemble of machine learning classifiers comprising a plurality of distinct machine learning classifiers, wherein each of the plurality of distinct machine learning classifiers is configured to generate a distinct archetype classification label upon a detection of a distinct archetype data feature within the extracted archetype data features, wherein processing the electronic communication data includes: generating by the plurality of distinct machine learning classifiers one or more archetype machine learning classification labels for the at least one online user based on one or more distinct archetype data features of the extracted archetype data features; applying a global archetype classification threshold to the one or more archetype machine learning classification labels; wherein identifying the archetype classification for the at least one online user includes outputting the archetype classification that maps to the one or more archetype machine learning classification labels that satisfies or exceeds the global archetype classification threshold.

In one embodiment, the global archetype classification threshold relates to a minimum required likelihood or probability that the archetype data features indicate an associated archetype classification label or archetype classification for the at least one online user.

In one embodiment, the electronic communications server accesses the electronic communication data generated, by the at least one online user, while operating one or more online third-party service providers including one or more of online networking services and email communication services.

In one embodiment, the system includes deploying the archetype network mapping via an interface of an online networking environment implementing by an online networking service.

In one embodiment, each of the plurality of online users within the archetype network mapping is represented as a distinct node within a graphical representation of the archetype network mapping; the method further comprising: identifying an interaction of user with a node within the graphical illustration of the archetype network mapping; in response to identifying the interaction, automatically deploying an electronic communication composition section within an interface of an online communication environment for generating and routing an electronic communication to the online user.

In one embodiment, an online method that enables intelligent online user classification and archetype detection within an electronic communications environment based on electronic communications data includes: at an electronic communication networking service: an electronic communications server that accesses electronic communication data exchanged between a plurality of online users; an electronic communication processing circuit that processes the electronic communication data by: (i) extracting archetype data features from the electronic communication data; (ii) allowing the extracted archetype data features, as input, into a machine learning classification system; (iii) identifying, by the machine learning classification system, at least one archetype classification that relates to at least one distinct online user archetype of a plurality of distinct online user archetypes; wherein the electronic communications service: generates an archetype network mapping comprising a plurality of online users each having one or more associated archetype classification labels and that illustrates network connections between each of the plurality of online users; updates the archetype network mapping to associate the at least one archetype classification to the at least one online user.

In one embodiment, the method includes implementing a machine learning system comprising an ensemble of machine learning classifiers comprising a plurality of distinct machine learning classifiers, wherein each of the plurality of distinct machine learning classifiers is configured to generate a distinct archetype classification label upon a detection of a distinct archetype data feature, wherein processing the electronic communication data includes: generating by the plurality of distinct machine learning classifiers one or more archetype machine learning classification labels for the at least one online user based on one or more distinct archetype data features of the extracted archetype data features; applying a global archetype classification threshold to the one or more archetype machine learning classification labels; wherein identifying the archetype classification for the at least one online user includes outputting the archetype classification that maps to the one or more archetype machine learning classification labels that satisfies or exceeds the global archetype classification threshold.

In one embodiment, the global archetype classification threshold relates to a minimum required likelihood or probability that the archetype data features indicate an associated archetype classification label or archetype classification for the at least one online user.

In one embodiment, the method includes deploying the archetype networking mapping via an interface of an online networking service.

In one embodiment, each of the plurality of online users within the archetype network mapping is represented as a distinct node within a graphical representation of the archetype network mapping; the method further including: selecting a node within the graphical illustration of the archetype network mapping; and responsive to the selecting the node, automatically presenting via an interface of an online networking environment one or more options for establishing an electronic communication with the at least one online user and/or routing an electronic message to the at least one online user.

In one embodiment, each of the plurality of online users within the archetype network mapping is represented as a distinct node within a graphical representation of the archetype network mapping; the method further including: identifying an interaction of user with a node within the graphical illustration of the archetype network mapping in response to identifying the interaction, automatically deploying an electronic communication composition section within an interface of an online communication environment for generating and routing an electronic communication to the online user.

In one embodiment, the method further includes receiving a search query; responsive to receiving the search query, automatically displaying the archetype network mapping via an electronic communication interface of an online electronic communication environment.

In one embodiment, the search query comprises a specific archetype classification label assignable to online users.

In one embodiment, the method includes receiving a search query; responsive to receiving the search query, automatically displaying the network mapping via a networking interface of an online networking environment.

In one embodiment, the archetype networking mapping comprises a searchable graphical illustration; in response to receiving a search query for an archetype classification label of an online user, prominently identifying one or more nodes within the graphical illustration of the archetype network mapping that satisfy the search query, wherein the one or more nodes comprise one or more online users; and prominently identifying the one or more nodes within the graphical illustration of the archetype network mapping includes modifying a visual appearance of the one or more nodes thereby distinguishing the one or more nodes from other nodes of the graphical illustration of the archetype network mapping.

In one embodiment, the archetype network mapping includes an electronic communication path from a user that provided the search query to an online user or node within a graphical illustration of the archetype network mapping; and displaying the archetype network mapping includes prominently identifying the electronic communication path within the graphical illustration of the archetype network mapping; and prominently identifying the electronic communication path within the graphical illustration of the archetype network mapping includes modifying a visual appearance of the electronic communication path thereby distinguishing the electronic communication path from other electronic communication paths of the graphical illustration of the archetype network mapping.

In one embodiment, an online system that enables intelligent online user archetype classification within an email communications environment based on email communications data includes: an electronic communications server that accesses email communication data generated by at least one online user; an email communication processing circuit that processes the email communication data by: (i) extracting archetype data features from the email communication data; (ii) allowing the extracted archetype data features, as input, into a machine learning classification system; (iii) identifying, by the machine learning classification system, at least one archetype classification that relates to at least one distinct online user archetype of a plurality of distinct online user archetypes; wherein the electronic communications server: generates an archetype network mapping comprising a plurality of online users each having one or more associated archetype classification labels and that illustrates network connections between each of the plurality of online users; updates the archetype network mapping to associate the at least one archetype classification to the at least one online user.

### BRIEF DESCRIPTION OF THE FIGURES

FIG. 1 illustrates a system 100 in accordance with one or more embodiments of the present application;

FIG. 2 illustrates a method 200 in accordance with one or more embodiments of the present application;

FIG. 3 illustrates a method 300 in accordance with one or more embodiments of the present application;

FIGS. 4A-4B illustrate example schematics for implementing portions of a method in accordance with one or more embodiments of the present application;

FIG. 5 illustrate an example schematic for implementing portions of a method in accordance with one or more embodiments of the present application;

FIG. 6 illustrate an example schematic for implementing portions of a method in accordance with one or more embodiments of the present application;

FIG. 7 illustrate an example schematic of a network mapping in accordance with one or more embodiments of the present application;

FIG. 8 illustrate an example schematic for implementing portions of a method in accordance with one or more embodiments of the present application;

FIG. 9 illustrate another example schematic for implementing portions of a method in accordance with one or more embodiments of the present application;

FIG. 10 illustrate another example schematic of a network mapping in accordance with one or more embodiments of the present application.

### DESCRIPTION OF THE PREFERRED EMBODIMENTS

The following description of the preferred embodiments of the present application are not intended to limit the inventions to these preferred embodiments, but rather to enable any person skilled in the art to make and use these inventions.

### 1. System for User Identification Based On Electronic Communication Data

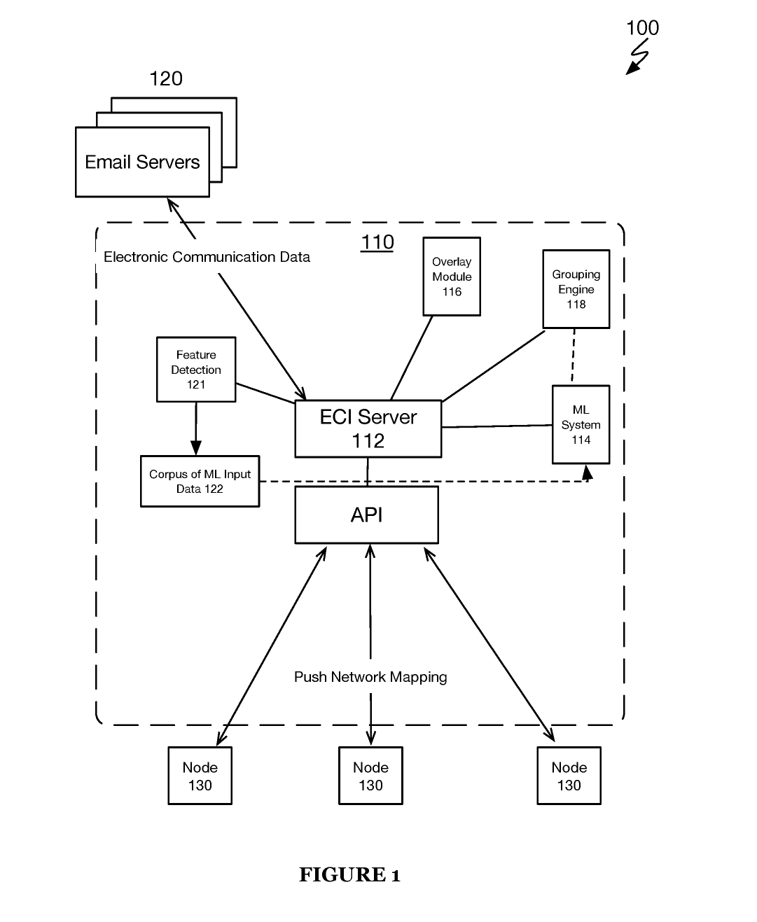

As shown in FIG. 1, a system 100 for classifying communication nodes operating within an electronic communication environment includes an electronic communication platform 110, a plurality of mail servers 120, and a plurality of communication nodes 130. The electronic communication platform 110 may include an electronic communication integration server 112, a machine learning system 114, an overlay module 116, and a grouping engine 118.

The system 100 functions to provide one or more classifications for a communication node based on (historical or real-time) electronic communications of the communication node and in some embodiments, activities of the communication node within the electronic communication environment. A communication node as referred to herein may refer to an electronic communication user and/or a computing system that is operated or used by an electronic communication user. Thus, a communication node may be defined by a user profile, a user account, and/or user dataset of a user involved in exchanges of electronic communication in any suitable electronic communications environment. Accordingly, the system 100 functions to evaluate electronic communications (data) exchanged and/or shared between a plurality of communication nodes (thousands to millions of communication nodes) and evaluate the activities of communication nodes with the electronic communications environment to determine one or more classifications that are line with propensities of the of users associated with or operating the communication nodes and one or more classifications that may estimate a trade or occupation of users associated with the communication nodes. Once the one or more classifications of the communication nodes have been identified by the system 100, the system 100 may additionally generate networking mappings (e.g., social networking maps, affinity networking maps, etc.) of the communication nodes that establish communication (and/or relationship) connection pairs of communication nodes. The system 100 may function to use the network mappings of communication nodes to generate user interface tools that may be used to expedite communications (e.g., communication routing, efficient electronic communication composition, etc.) thereby improve an electronic communication environment.

The electronic communication integration server 112 of the platform 110 preferably functions to extract electronic communications, such as email communications, chat messaging communications, social networking communications, and/or professional networking communications from the plurality mail servers 120 (e.g., messaging servers, electronics communications servers, etc.). In many embodiments, the electronic communication integration server 112 functions as a proxy server (or API server) capable of interfacing with a plurality of email servers for directing email communications to and from the plurality of email servers to corresponding user email accounts and client devices. Additionally, the electronic communication integration server 112 may additionally interface with any type of electronic communication server or platform including chat communication servers, text messaging communication servers, social networking communication servers, and the like. The email communications extracted from the mail servers 120 may be associated with one or more user accounts or one or more user devices configured to transmit and receive electronic mail communication using the electronic communication integration platform 110.

The electronic communication integration server 112 may extract email communications on a periodic or continuous basis (e.g., in real-time or near real-time). Additionally, or alternatively, the electronic communication integration server 112 may extract email communications based on a request by a user client device or an indication by the plurality of mail servers 120 that email communications are available for extraction. Additionally, or alternatively, the electronic communication integration server 112 may automatically receive email communications from the plurality of mail servers 120 without expressly making an extraction request or the like. The automatic transmission of email communications from the plurality of mail servers 120 to the electronic communication integration server 112 may be based on a predetermined or dynamic schedule negotiated between the electronic communication integration server 112 and the plurality of mail servers 120.

Additionally, the electronic communication integration server 112 in cooperation with the overlay module 116 functions to generate overlay data for an email communication and, functions to store the generated overlay data for the email communication. Preferably, the electronic communication integration server 112 functions to permanently store the overlay data so long as the associated email communication persists within the mail server (e.g., mail servers 120).

Upon receipt by the electronic communication integration server 112 of an email communication request (e.g., request for email list of a recipient user) from one or more of the plurality of communication nodes 130, the electronic communication integration server 112 functions to pull or extract email communications from the plurality of mail servers 120. Specifically, the email communication request from the communication nodes 130 may include user identification information that allows the electronic communication integration server 112 to correspond the user identification information to an email communication account at the one or more of the plurality of mail servers 120.

Once the electronic communication integration server 112 receives the email communications from the plurality of mail servers 120, the electronic communication integration server 112 functions to generate overlay data for the email communications and join or integrate the generated overlay data to the email communications thereby generating integrated email communications. Following, the electronic communication integration server 112 functions transmits the integrated email communication via a communication network to a communication node 130 of the recipient user requesting the email communications.

In a preferred embodiment, the electronic communication integration server 112 may function to generally monitor and collect or analyze the electronic communications exchanged between the plurality of communication nodes 130.

The electronic communication integration server 112 may be implemented via one or more computing servers. Additionally, or alternatively, the electronic communication integration server 112 may be implemented via a distributed computing network (e.g., the cloud). It shall be noted that while, the electronic communication integration server 112 is preferably implemented and maintained by a separate entity different from an entity maintaining the plurality of mails servers 120, in some embodiments, the electronic communication integration server 112 and mail servers 120 may be maintained or implemented by a same entity or may be combined into a single computing server.

The machine learning system 114 of the electronic communication platform 110 may function to recommend or suggest classifications (e.g., labels) of communication nodes. The machine learning system 114 may implement a trained machine learning model or an ensemble of trained machine learning models that function to use as machine learning input feature vectors extracted from any type or kind of electronic communication data and/or from communication node data (including node activity data) of the system 100 to identify suitable classifications. The machine learning system 114 may suggest or recommend archetype classifications and potentially additional labels (e.g., trade or occupation labels) for a communication node based on attributes and/or features of the electronic communication data (e.g., messaging data) associated with the communication node.

An archetype classification, as referred to herein, generally relates to a predetermined model that represents a type of user and/or communication node that may operate in an electronic communication environment. The predetermined model may be defined by a combination of identified patterns and attributes that exemplify a quintessence of a user (e.g., an online user) and/or a communication node type operating within the environment. In some embodiments, a determination of an archetype classification may be accomplished via one or more archetype classification machine learning models that function to predict or estimate an archetype classification for a user and/or a communication node based on electronic communication data associated therewith. In a further embodiment, a determination of an archetype classification may be accomplished via one or more archetype classification heuristics defined by the predetermined model. In such further embodiment, characteristics and/or attributes of the electronic communication data of a user and/or communication node operating in the electronic communication environment may be compared to and/or filtered through the archetype classification heuristics to determine a probable or percentage match.

In the system 100, a plurality of archetype classifications may be employed where each archetype classification is preferably defined by a distinct predetermined model and/or dynamic model (e.g., continually improving model based on new training inputs). It shall be noted that an archetype classification may evolve based on changes and/or evolutions of the users and/or communication nodes within an electronic communication environment and their associated electronic communication data. As the users and/or communication nodes evolve the electronic communication data associated with these actors may also evolve enabling the system 100 to redefine or retrain the predetermined models defining an archetype.

A trade or occupation classification or label, as referred to herein, generally relates to an estimation or suggestion of a probable trade or occupation of an actor (e.g., user, person, and/or device) operating within the electronic communication environment. An actor, as referred to herein, may broadly refer to a user, person, and/or device that may be classified according to the one or more systems and/or methods described herein. A user and/or device may work individually or in combination within the electronic communication environment and may jointly or individually be referred to as a communication node when operating within the electronic communication environment. The generation and/or calculation of the trade or occupation classification or label may be based on electronic communication data associated with the actor. A determination of a trade or occupation classification or label may be determined in a manner similar as an archetype classification by using one or more machine learning models or predetermined heuristics.

Additionally, the machine learning system 114 may function to train one or more machine learning models via a machine learning training engine. The machine learning training engine may include a variety of selectable training algorithms, hyperparameters, training data, and the like that may be used in one or more machine learning training processes. Additionally, the machine learning system 114 may function to identify or classify features of the accessed or collected electronic communication data. The machine learning system 114 may be implemented by one or more computing servers having one or more computer processors (e.g., graphics process units (GPU), central processing units (CPUs, MCUs, etc.), or a combination of web servers (e.g., public or Internet servers) and private servers) that may function to implement one or more ensembles of machine learning models. The ensemble of machine learning models may include multiple machine learning models that work together to identify communication node groupings and classify features of the node groupings. The machine learning system 114 may function to communicate via one or more wired or wireless communication networks. The machine learning system 114 may additionally utilize input from various other data sources (e.g., outputs of system 100, system 100 derived knowledge data, external entity-maintained data, etc.) to continuously improve or accurately tune weightings associated with features of the one or more of the machine learning models of the system 100.

The machine learning system 114 may employ any suitable machine learning including one or more of: supervised learning (e.g., using logistic regression, back propagation neural networks, random forests, decision trees, etc.), unsupervised learning (e.g., using an Apriori algorithm, k-means clustering, etc.), semi-supervised learning, reinforcement learning (e.g., using a Q-learning algorithm, temporal difference learning, etc.), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4-5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, boostrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) can be used in detecting cohorts of communication nodes and/or other data relevant to system 100.

The grouping engine 118 includes a grouping server that is in operable communication with the machine learning system 114 and a grouping database. The grouping engine 118 may enable cohort detection functionality that enables the grouping server to generate or suggest one or more groups or individuals based on outputs of the machine learning system 114. Additionally, or alternatively, the cohort detection functionality may be implemented to identify any type of appropriate affiliation based on identified electronic communications. Some example affiliations include, but should not be limited to, any associate of a recipient of the communication, one or more known or prospective collaborators of the recipient, one or more teams (e.g., baseball team, legal team, marketing team, etc.) associated with the recipient, and the like. Specifically, the grouping engine 118 functions to generate or receive an analysis of an inbound email communication and based on the analysis, determine one or more cohorts including one or more persons and/or groups that a user should evaluate for a potential chat communication session. These identified one or more persons and/or groups may be associated or linked to a recipient user of an email as a cohort, associate, team, and/or collaborator.

The plurality of mail servers 120 may include a plurality of mail servers or electronic communication servers maintained by a plurality of disparate entities. The mail servers 120 may include outgoing mail servers, such as Simple Mail Transfer Protocol (SMTP) servers, and incoming mail servers, such as Post Office Protocol (POP3), Internet Message Access Protocol (IMAP), and modern application programming interfaces (API), such as a Representational state (ReST) API. The plurality of mail servers 120 should not be limited to the example mail servers described above and can be encompassed by any suitable mail server or electronic communication server.

The plurality of communication nodes 130 may include one or more user client devices connected over a network (e.g., the Internet) to the electronic communication integration platform no. The plurality of communication nodes 130 may include any type of device capable of receiving and presenting a content of an electronic communication (e.g., an inbound email communication to a user). For instance, the plurality of communication nodes 130 may include, but are not limited to, mobile computing devices (e.g., mobile phones, tablets, etc.), desktop computers or laptops, virtual and/or personal assistant devices (e.g., Alexa, Google Home, Cortana, Jarvis, etc.), chatbots or workbots, etc. A communication node may additionally include an electronic communication user that functions to operate or use the one or more computing devices of a communication node. Thus, in some embodiments, the communication may be a combination of an electronic communication user and a computing device that may be used for implementing electronic communications. An intelligent personal assistant devices (e.g., Alexa, etc.) may be any type of device capable of touchless interaction with a user to performing one or more tasks or operations including providing data or information and/or controlling one or more other devices (e.g., computers, email interfaces, etc.). Thus, an intelligent personal assistant may be used by a user to perform any portions of the methods described herein, including the steps and processes of method 200 and/or method 300, described below. Additionally, a chatbot or a workbot may include any type of program (e.g., slack bot, etc.) implemented by one or more devices that may be used to interact with a user using any type of input method (e.g., verbally, textually, etc.). The chatbot or workbot may be embedded or otherwise placed in operable communication and/or control of a communication node and thus, capable of performing any process or task of a communication node including, but not limited to, acquiring and providing information (e.g., email data) and performing one or more control operations (e.g., triggering a communication composition, chat request or chat session etc.). The plurality of communication nodes 130 may be operable to implement an email client application or email browser that enable the communication nodes 130 to receive, interact with, and transmit email communications.

It shall be noted that the archetype classification and/or electronic communication/networking service user classification may be enhanced or be used to enhanced the one or more inventions described in U.S. Patent Application No. 62/581,215, U.S. patent application Ser. No. 15/995,865, and U.S. Patent Application No. 62/612,809, which are all incorporated herein in their entireties by this reference.

### 2. Method for Communication Node Classification Based on Electronic Communication Data

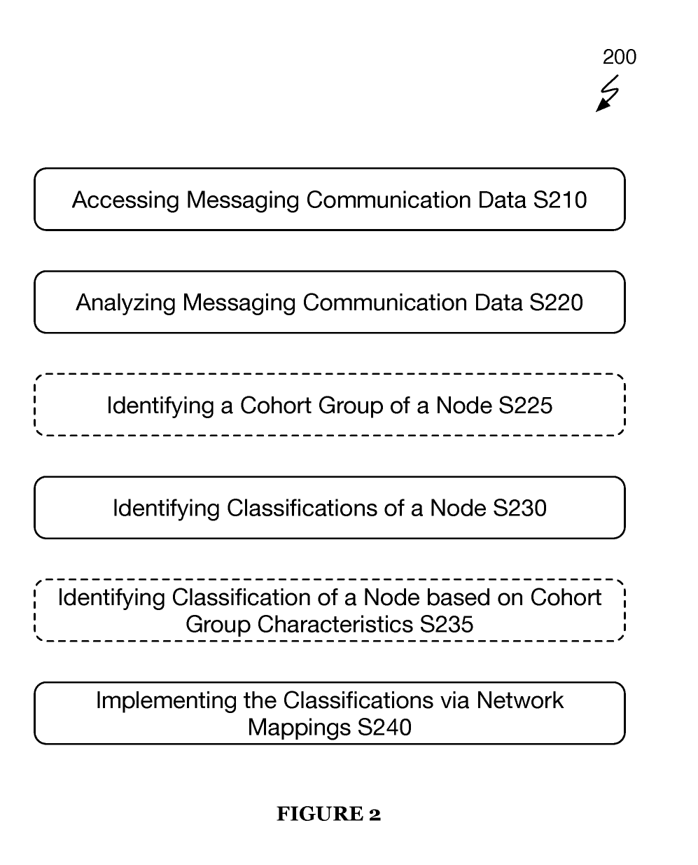

As shown in FIG. 2, a method 200 for classifying communication nodes based on messaging communication data includes accessing messaging communication data of a communication node S210, assessing the messaging communication data S220, identifying one or more classifications for the communication node S230, and implementing the identified one or more classifications of the communication node via one or more network mappings associated with the communication node S240. Optionally, the method 200 may include identifying a cohort group associated with the communication node S225 and identifying a classification of the communication node based on messaging communication data involving the communication node and dynamics and/or characteristics of the identified cohort group S235.

The method 200 functions to enable an archetype classification of communication nodes operating in an electronic communications environment. Each communication node operating within the environment is preferably associated with a user and/or a user account (or profile) and typically, an electronic computing medium (e.g., a mobile computing device, a desktop computing device, etc.) for exchanging electronic messages within the electronic communications environment. The method 200 preferably implements a plurality of pre-existing archetypes and/or classifications that may be applied to a communication node or to which a communication may be assigned. By accessing and analyzing the electronic communication data associated a communication node, the method 200 may function to determine a classification for each communication node operating within the electronic communications environment. The method 200 may apply the determined classification for each communication node to a networking mapping of communication nodes thereby enabling an improved and productive electronic communications environment by allowing select communication nodes to make communication routing decisions using the node classification data provided with the network mapping.

S210, which includes accessing messaging communication data of a communication node, functions to access or collect messaging communication data generated and/or received by the communication node. The messaging communication data preferably derives from an electronic communication that includes electronic message content, where the electronic message content includes a verbal, written, or a recorded communication. The electronic message content of the electronic communication may additionally include digital media content, digital attachments (e.g., electronic documents, etc.), and any suitable electronic medium that may be transmitted by a sender to a recipient node. In a preferred embodiment, the accessed messaging communication data comprises email communication data accessed from a corpus of email messages associated with the communication node. However, the accessed messaging communication data may include one or more or a combination of instant messaging data, social networking messaging data or posts, text messaging data, voicemail data, chat messaging data, video chat messaging data, and/or any realizable electronic communication medium and the like.

Accordingly, in some embodiments, S210 may function to collect electronic communications data involving one or more online users from one or more third-party service providers including one or more of online networking services and one or more email communication services or the like.

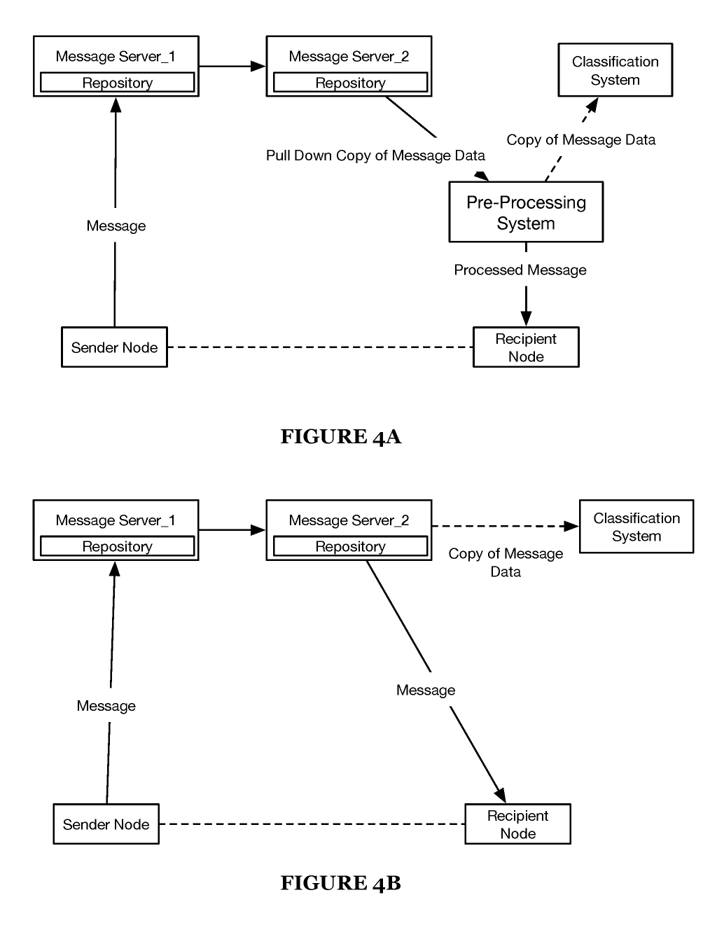

In a first implementation, S210 may function to access the messaging communication data of a messaging communication involving the communication node while the messaging communication is in transition between communication nodes, as shown in FIG. 4A, for example. That is, while the messaging communication is being transmitted by or being received by the communication node, S210 may function to access any content and/or data (including metadata) associated with the messaging communication. In some embodiments, while the messaging communication is in transition, messaging communication data may be temporarily stored for pre-processing or the like prior to being delivered to a recipient (e.g., the communication node) of the messaging communication. In such embodiment, S210 may access the messaging communication data contemporaneous with a pre-processing step (e.g., during augmentation or synthesis of overlay data with the messaging communication, etc.).

In a second implementation, S210 may function to access the messaging communication data at a repository, such as a messaging communication computing server and/or a database storing messaging communication data, as shown by way of example in FIG. 4B. In this second implementation, S210 may function to access recent (or near real-time) messaging communication data in a raw form (or without pre-processing) as well as historical messaging communication data. Accordingly, an archetype classification assessment of the communication node may be performed using a combination of recent communication data and historical messaging communication data associated with the communication node.

It shall be noted that a combination of the first and second implementations may be performed by S210.

S220, which includes assessing the messaging communication data of the communication node, functions to analyze a corpus of messaging communication data derived from an aggregate of accessed message communications involving the communication node. Specifically, S220 functions to analyze attributes of the corpus of messaging communication data to identify prevalent communication patterns, communication purposes, communication metrics, and the like (collectively, “communication factors”). Generally, the identified prevalent communication factors may typically include factors that indicate how a communication node interacts and communicates with other nodes. The identified prevalent communication factors may be used in the method 200 as factors for identifying a prevalent archetype or classification of the communication node.

Accordingly, S220 may function to parse data elements or features (e.g., using a parsing circuit or engine) from and measure various metrics of the corpus of messaging communication data that support one or more of the communication factors. In one variation, S220 may function to extract various feature vectors from electronic communication data using a (archetype) feature extractor (e.g., a deep machine learning model or any suitable high-level feature extractor). Additionally, or alternatively, S220 may function to aggregate the data elements parsed from the messaging data and the measured metrics and arrange the data elements and metrics according to their kind. For example, S220 may function to measure a responsiveness metric for each of a plurality of messaging communications received by the communication node. In such example, S220 may function to measure a time that it took the communication node to reply to each of the plurality of messaging communications. The measured responsiveness metrics may be arranged and/or stored in association with each other in a common data storage location. Similar measurements may be performed by S220 for any measurable metric (including quantitative and qualitative metrics) of messaging communication data including, responsiveness, productivity, utilization, knowledge consumption or knowledge propagation, sentiment, node connection strength, and the like. Each of the fore-mentioned communication factors may be measured by S220 and arranged according to their kind (e.g., placed in disparate factor buckets, etc.) that allows, in one implementation, the method 200 to use and/or provide the communication factor data as input into one or more archetype classification models.

In one implementation, S220 functions to apply a plurality of filters to the corpus of messaging communication data that operate to filter data elements and communication metrics from the corpus of messaging communication data. In such implementation, each of the plurality of filters may be configured to filter a distinct data element or distinct communication metric from the corpus of messaging communication data. For instance, there may be a plurality of content filters or sub-filters used to identify or filter messaging communication data about specific subject areas (e.g., subject area filters, key term filters, etc.). In another example, S220 may implement a plurality of sentiment filters that include a plurality of sub-filters used to filter messaging communication data according to a detected sentiment. It shall be noted that S220 may function to implement any suitable filter for any metric (qualitative or quantitative) and/or data element identifiable in messaging communication data.

Optionally or alternatively, S225, which includes identifying a cohort group of the communication node, functions to assess messaging communication data of the communication node with respect to an identified cohort group of the communication node. The identified cohort group may include a plurality of communication nodes (that includes the subject communication node) that share one or more meaningful connections with each other based on commonalities determined from messaging communication data of the members of the cohort group. That is, for example, a cohort group of communication nodes may be defined based on users associated with the communication nodes sharing a common geographic location (e.g., Ann Arbor, Mich.) as well as common interests in subject areas (e.g., artificially intelligent startups or the like). These commonalities may be identified and/or determined based on an analysis of the real-time and/or historical messaging communication data of the members of the cohort group.

Accordingly, S225 may function to process and analyze the messaging communication data of the communication node that have been shared with and/or received from member communication nodes of the cohort group. That is, only and/or primarily messaging communication data involving member communication nodes of the cohort group may be considered for processing and analysis to assist in determining an archetype classification for the subject communication node. In this manner, an archetype classification may be identified for each cohort group in which the subject communication node participates in based primarily on the messaging communication data shared between the subject communication node and members of a given cohort group.

In a similar manner as performed in S220, S225 may function to parse and/or filter data elements and metrics of the messaging communication data of the communication node to identify prevalent communication factors that may be useable as input (into S230) for identifying an archetype classification for the communication node.

S230, which includes identifying one or more classifications for the communication node, functions to receive the parsed and/or filtered data elements to use as input to identify an archetype classification for the communication node. S230 may function to identify an archetype classification for the communication node by passing the communication factors data input through one or more of archetype classification machine learning models, archetype classification heuristic models, outlier detection models, and the like.

In a first implementation, the method 200 may implement an ensemble of machine learning models configured to estimate an archetype classification for a communication node. The ensemble of machine learning models preferably includes a plurality of trained sub-machine learning models (sub-models). Each sub-model of the ensemble machine learning models may be specifically trained to detect or estimate a specific archetype classification. For instance, a first sub-model of the ensemble may be configured to output a first archetype classification label for a first archetype and a second sub-model of the ensemble may be configured to output a second archetype classification label for a second archetype and the like. It shall be noted that there may be any number of sub-models for generating any number of distinct archetype classification labels.

The archetype classifications may include a plurality of distinct archetype classifications. Example archetype classifications may include Maven (e.g., an outstanding and/or high performing communication node), Producer (e.g., a highly productive communication node), Ball Dropper (e.g., an often-unreliable communication node), Connector (e.g., a communication node highly capable of placing disparate nodes in communication), and the like. The plurality of archetype classifications may include any number of varying archetypes classifications. Accordingly, for each archetype classification, the method 200 functions to implement a sub-model that is trained with archetype-specific training data that enables the sub-model to identify when the attributes or characteristics of a communication node matches or doesn't match the archetype.

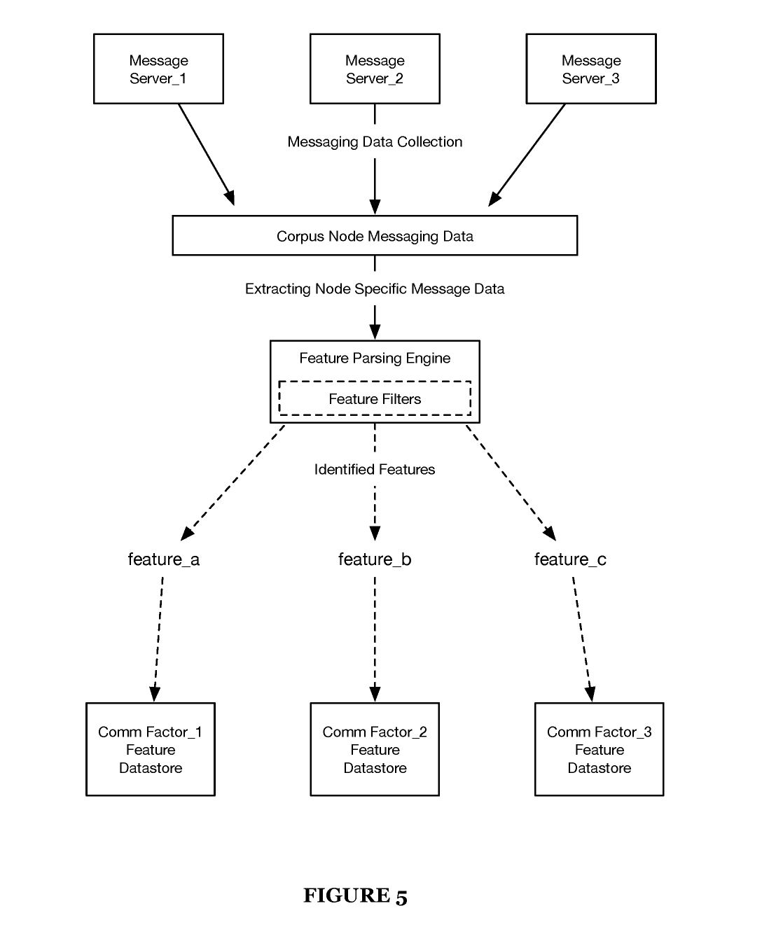

In this first implementation, S230 may function to receive the communication factors data (or archetype feature data) as input data into the ensemble of machine learning models. At the ensemble of machine learning models, the communication factors data may traverse each of the sub-models. That is, each of the sub-models may function to ingest the communication factors data to generate an estimation (or likelihood) that the communication factors data indicates an associated archetype classification. Accordingly, each of the sub-models may generate an estimation based on the communication factors data, as shown in FIG. 5, for examples. The sub-models preferably function to process the communication factors data in parallel (and asynchronously) or synchronously. However, it shall be noted that the sub-models may function to process the communication factors data in any order or manner.

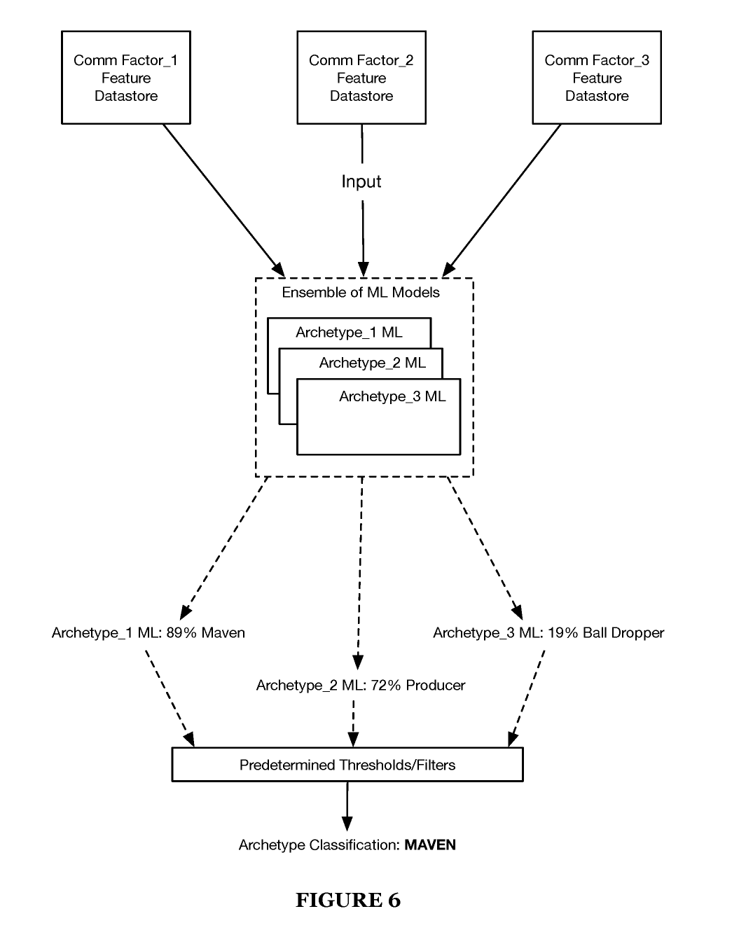

Additionally, or alternatively, the ensemble of machine learning models may implement a global archetype classification threshold that may be used to filter the estimations of the plurality of sub-models, as shown by way of example in FIG. 6. In such embodiments, each estimation of the sub-models comprises a probability (e.g., 23%, 75%; or low, high, etc.) that the communication factors data should be classified as an associated archetype classification. For instance, a first sub-model may output that there is a 23% probability that the communication factors data indicates a first archetype classification and a second sub-model may output that there is a 75% probability that the communication factors data indicates a second archetype classification. S230 may function to filter the sub-model estimations against the global archetype classification threshold such that the sub-model estimations that meet and/or satisfy the threshold may be passed through or output by the ensemble as a possible classification for the communication node. Still continuing with the aforementioned example, if the global archetype classification threshold requires a 70% or greater confidence, the ensemble would output only the second archetype classification as a possible classification for the communication node.

In one variant, the ensemble of machine learning models may implement a specific archetype classification threshold for each sub-model such that if the estimation for a sub-model satisfies its respective specific archetype classification threshold, S230 may function to pass the sub-models classification as an output of the ensemble. It shall be noted that according to either the global archetype threshold or specific archetype threshold approach, it may be possible that the method 200 outputs multiple possible classifications for a communication node. In such cases, the method 200 may function to generate a composite of the classifications to form a single composite archetype classification (e.g., an emerging archetype classification or the like) or select the classification having the highest level of confidence.

In one variation, S230 may function to implement a plurality of distinct machine learning classification models that may operate in concert as an ensemble of machine learning classifiers. In such implementation, each of the plurality of distinct machine learning classification models may function to output a distinct machine learning classification label comprising a predicted archetype classification or label based on an input of one or more features extracted from the electronic communications data or features extracted from the communication nodes. Accordingly, each of the distinct machine learning classification labels may be mapped to a specific or predetermined archetype of a plurality of archetypes. Once a distinct machine learning classification label is generated, S230 may function to assign or map the classification label to the one or more communication nodes associated with the electronic communication data from which the input features were extracted.

It shall be noted that S230 may function to generate multiple distinct machine learning classification labels for a given communication node and thus, S230 may function to assign the one communication node multiple, distinct archetypes.

In another variation, S230 may function to implement an archetype classification circuit (implemented by one or more processors and/or one or more computing servers) that may function to identify or generate archetype classifications for each of a plurality of communication nodes (e.g., a plurality of online users) based on one or more distinct machine learning classification labels assigned to each of the plurality of communication nodes.

In a second implementation, the method 200 may implement a plurality of archetype classification heuristics for identifying a classification for a communication node. Each of the plurality of archetype classification heuristics may be associated with a distinct and different archetype classification. S230 may function to measure the communication factors data (input) against each of the plurality of archetype classification heuristics such that when a sufficient match is identified between the communication factors data and a specific archetype classification heuristic by S230, the method 200 may output the archetype classification of the matching heuristic as a probable archetype classification of the communication node. A sufficient match may be achieved based on a percentage match calculation between the communication factors data and an archetype classification data meeting or exceeding a local or global archetype classification threshold.

Once an archetype classification label for a subject communication node, S230 may additionally function to associated the archetype classification label with the subject communication node. Additionally, or alternatively, S235 may function to associate (e.g., tag, flag, digitally link, etc.) the archetype classification label with an electronic communication user account (e.g., user profile or user dataset) of an electronics communication user defining or that is affiliated with the communication node.

Optionally or alternatively, S235 includes identifying a cohort group-specific archetype classification label for a communication node based on an evaluation of messaging communication data involving the communication node and one or more member communication nodes in the cohort group and also, based on attributes and dynamics of the communication node. Preferably, S235 functions to identify features and/or calculate metrics (e.g., communication factors data) of message communications shared between the subject communication node and member communication nodes of the identified cohort group and use that communication factors data as input for identifying an archetype classification of the subject communication node. That is, a system implementing step S235 of the method 200 may function to identify a cohort group-specific archetype classification label for each cohort group in which a communication node is a member. For instance, if a communication node is a member of nine (9) disparate cohort groups, S235 may function to identify an archetype classification label for the communication node for each of the 9 disparate cohort groups. S235 may follow similar processes as described in S230 for identifying classification, such as providing the communication factors data as input to an ensemble of machine learning models and/or providing the input to a plurality of archetype classification heuristics to identify one or more archetype classifications of the communication.

In the variant of S235, the communication factors data acquired by S235 typically includes communication factors data derived from messaging communications data transmitted by and/or received by the subject communication node and member communication nodes of the identified cohort group. Additionally, or alternatively, the archetype classification thresholds implemented with the ensemble of machine learning models and/or the plurality of archetype heuristics may be defined, at least in part, by dynamics of the cohort group. For instance, if the cohort group is collectively a very high performing group, the thresholds for identifying a Ball Dropper archetype for a subject communication node operating in that cohort group may be set higher relative to other cohort groups that do not perform as highly since it is less likely that a communication node in such a group will be classified as a Ball Dropper.

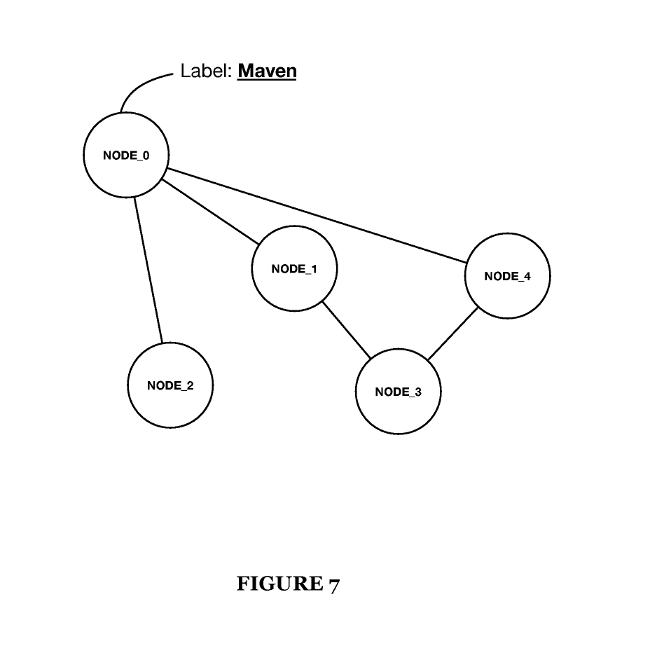

S240, which includes implementing the identified one or more classifications of the communication node via one or more network mappings associated with the communication node, functions to reveal or deploy the classification of the communication node within one or more network mappings, as shown in FIG. 7. The one or more network mappings may illustrate connections that may exist between a plurality of communications nodes. In a preferred embodiment, a network mapping may be defined by member communication nodes of an identified cohort group, as described in U.S. Patent Application No. 62/581,243, which is incorporated herein in its entirety by this reference. In such embodiment, the network mapping of the cohort group functions to graphically illustrate communication paths or various meaningful connections between each of the communication nodes of the cohort group in a format of a mapping with the nodes networked together.

Accordingly, S240 may function to modify or augment the one or more network mappings associated with the communication node with the one or more archetype classifications of the communication node. The networked mapping having the revealed archetype classification of the communication node may be perceivable to select member communication nodes within the identified cohort group and/or an outside communication node that may function to govern one or more communication nodes (including the subject communication node) of the identified cohort group. Therefore, the network mappings having the revealed archetype classifications may enable, at least, messaging communication routings (or task allocations) within the network mappings based on the revealed archetype classifications.

### 3. Method for Proving a Communication Node Based on Electronic Communication Data

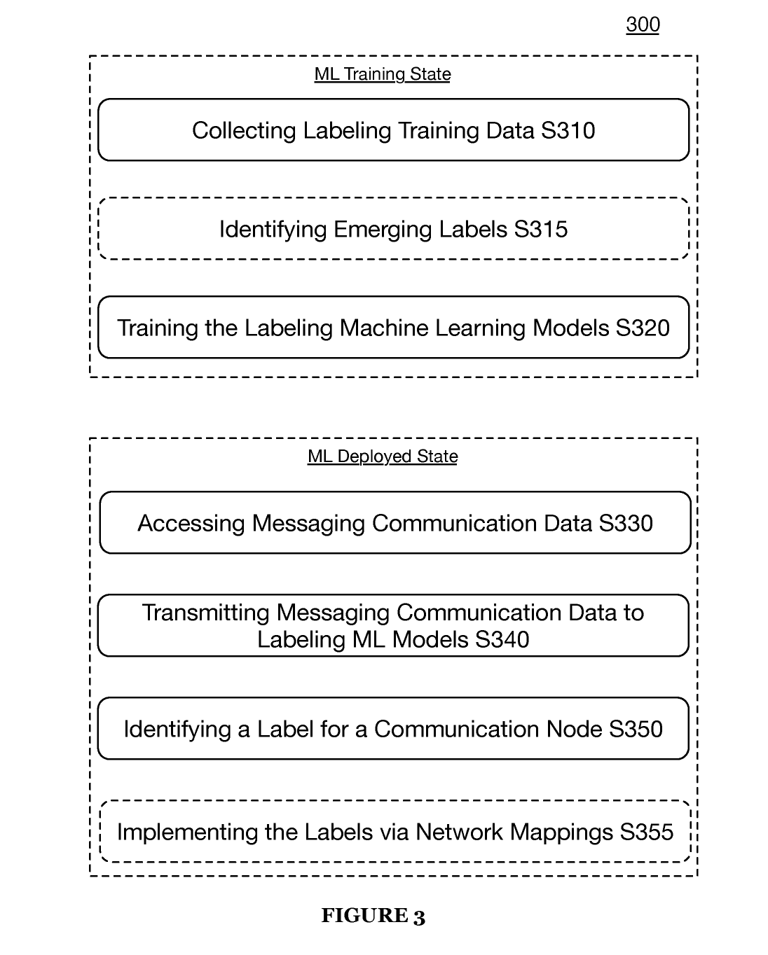

As shown in FIG. 3, a method 300 for proving a communication node based on electronic communication data includes collecting labeling training data from one or more sources S310, using the training data to train labeling machine learning models S320, accessing messaging communication data of an unlabeled and/or labeled communication node S330, passing the messaging communication data of the identified communication nodes to the trained specific label machine learning models S340, and using the messaging communication data as input into the labeling machine learning models to identify a label for the communication node S350. The method 300 optionally includes identifying emerging labels, functions to monitor custom label inputs S315 and implementing the selected label outputs of the communication node via one or more network mappings associated with the communication node S355.

The method 300 functions to prove a user associated with a communication node based on messaging communication data. Specifically, the method 300 functions to discover what a user and/or communication node “sounds like” based on content of their messaging communication data. Thus, in some embodiments, the method 300 may determine a trade or occupation classification or label that best fits what a user and/or communication “sounds like” (or “talks like” or “communications like”). For instance, if an analysis of a node's messaging data indicates that the node frequently exchanges messages with legal discussion or content, then the method 300 may determine that the node sounds like an attorney and responsively, generate a trade or occupation label of attorney that may be assigned to the communication node and/or user account associated with the communication node.

### 3.1 Training Communication Node Proving Machine Learning Models

S310, which includes collecting labeling training data from one or more data sources, functions to aggregate data that can be used to train and/or configure a labeling machine learning model to predict or recommend a label or classification of a communication node. The labeling training data preferably includes data related to a potential trade, practice, occupation, vocation, profession, or similar business path of a user associated with a communication node. Accordingly, the labeling training data may be any data, preferably digital data, that provides insight into a potential occupation (e.g., job or career).

In one implementation, the one or more data sources of labeling training data includes labeling input from a plurality of users or communication nodes operating in an electronic communication environment (e.g., email environment). In such implementation, users operating within the e-communication environment may be provided with one or more opportunities to provide labeling input with respect to one or more other users or communication nodes that the users communication with or otherwise, exchange messaging communication data. For example, via an email interface or chat interface, a user may be presented with a plurality of selectable labeling options for identifying a potential label of another user that the user is actively or have previously been in email communication or the like. The user may select a labeling option from among the plurality options that the user believes best describes the other user. Alternatively, if the user believes that the labeling options do not suitably characterize a potential occupation or trade of the other user, the user may have the option to provide an input response (e.g., type in) of a suitable/custom label.

S310, may function to periodically or continuously collect the labeling input responses from the one or more communication nodes (e.g., users of the electronic communication environment) and store the responses into an initial labeling input data store. In a preferred embodiment, S310 functions to monitor an accumulation of the labeling input response received for each individual communication node operating in the e-communication environment. Once an accumulated label input response has satisfied a statistical or otherwise, predetermined label threshold (e.g., 1011 label input responses), S310 may function to acquire that label and assign the label to the communication node and even more, assign the label to the messaging communication data associated with the communication node. Accordingly, S310 may function to store in association the acquired label and the messaging communication data.

Additionally, or alternatively, S310 may function to acquire a label for a communication node based on the label input response having a highest accumulated count. For instance, a communication node operating in the email communication environment may have three labeling vectors based on labeling input responses from other communication nodes operating in the email communication environment. In such instance, S310 may function to acquire a label of the three labeling vectors for the communication node having the highest vector value or accumulated label responses.

Additionally, or alternatively, S310 may function to collect and ingest labeling data from one or more labeling data sources external to the electronic communications environment. For instance, S310 may identify one or more authoritative or assistive sources of data that function to assist in defining communication patterns (e.g., how a communication node sounds like) of a communication node that is associated with a particular occupation or trade label. The external labeling data sources may include one or more trade or occupation-specific books, journals, blogs, and any suitable content.

S310 may function aggregate labeling response data from the community of communication nodes operating in the e-communication environment to form or define a first training corpus and aggregate the external labeling data to form or define a second training corpus for the labeling machine learning algorithms. In this way, a system implementing the training of the labeling machine learning models may function to implement a suitable mix of the first and second training corpus and possibly, further configure the labeling machine learning models to weight the first and second training corpus differently. It shall be noted that S310 may function to aggregate training data to define any number of suitable training corpus.

Optionally, S315, which includes identifying emerging labels, functions to monitor custom label inputs (e.g., a label presented by a communication node other than the label options presented by a system implementing the method 300) and acquire those custom label inputs that have emerged as possible or future standard label for communication nodes and/or users of the e-communication environment. Accordingly, S315 may function to monitor an accumulation of the custom label inputs and, in some embodiments accumulate custom label inputs that are similar or same in scope. At a time when an accumulation of a custom label input has satisfied a threshold, S315 may function to implement or add the custom label (or emerging label) in a training data queue so that the custom label and associated messaging communication data of the label communication node may be used as training data for a new labeling model or the like. Additionally, or alternatively, S315 may function to store the accumulated custom label input and messaging communication data in further training corpus

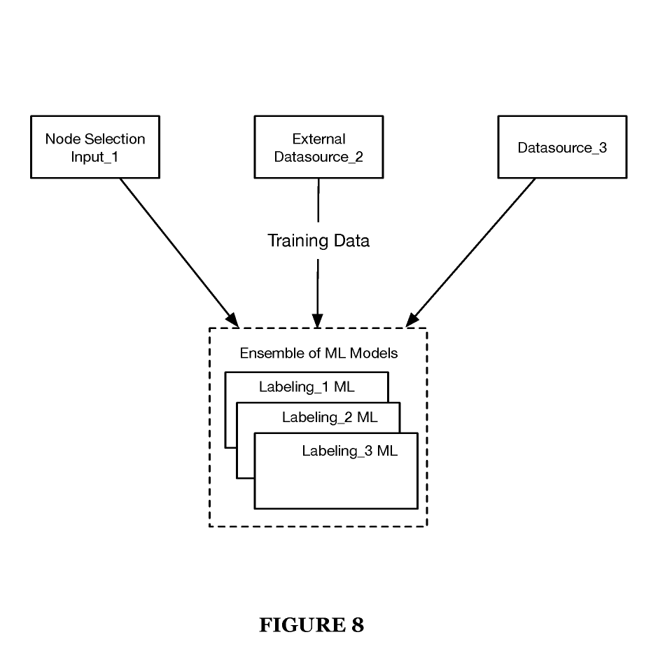

As shown in FIG. 8, S320, which includes training the machine learning model with the training data, functions to provide labeling training data as training input into a specific label machine learning model. In some embodiments, a system implementing the method 300 may include a plurality of specific label machine learning models (e.g., an ensemble of machine learning). Each of the plurality of specific machine learning models may be trained to predict a specific label. For instance, if the system includes three specific label machine learning models, a first model may be trained to detect communication nodes that should be labeled as “Investor,” a second model may be trained to detect users that should be labeled as “Software Engineer,” and a third model may be trained to detect users that should be labeled as “Patent Attorney.”

For each specific labeling machine learning model, S320 functions to identify one or more label training corpus for the specific model and provide label training data to the specific model. In a preferred embodiment, in the case of a plurality of labeling training corpus for a specific model, S320 functions to selectively choose which of the plurality of labeling training corpus that may provide training data to the specific labeling model. This enables a system implementing the method 300 to control a level of exposure and influence that each respective labeling training corpus has to the specific labeling model.

Additionally, or alternatively, S320 may function to reconfigure (re-train or continue training) a specific labeling model, as required, to achieve desired predictive labeling results. In such instance, S320 may function to adjust or modify the features and/or the weightings associated with the features of the specific labeling model.

Accordingly, once a specific labeling model is trained, S320 may function to deploy the trained specific labeling model into (or such that it receives data from) the electronic communications environment.

### 3.2 Implementing the Trained Communication Node Proving ML Models

Once a trained specific labeling model is deployed, S330, which includes identifying unlabeled (and/or labeled) communication nodes and assessing messaging communication data, functions to evaluate messaging communication data of communication nodes and/or users of the electronic communications environment. In a preferred embodiment, S330 functions to identify the communication nodes and/or users operating in the e-communication environment for which a label has not been proposed or assigned thereto by a component of a system implementing the method 300. In such instances, S330 may periodically and/or continuously monitor and access messaging communications involving the identified unlabeled communication nodes.

In some embodiments, S330 may additionally or alternatively function to monitor and access messaging communication data of communication nodes with a proposed label. In such embodiments, S330 operates to monitor a validity of the label applied to labeled communication nodes to ensure that the label continues to correspond to estimate trade or occupation associated with the labeled communication node. In the instance, that the messaging communication data of a labeled communication node begin to migrate or change to another label, S330 functions to identify the new or other label and propose the new or other label for the communication node.

Additionally, or alternatively, S330 may function to access the messaging communication data of the communication nodes in any suitable manner including, but not limited to, by accessing and reviewing messaging communications involving the communication nodes that are in transit or transition, accessing a corpus of recent and/or historical messaging communications of the communication nodes stored in a (remote) database or the like.

S340, which includes passing the messaging communication data of the identified communication nodes to the trained specific label machine learning models, functions to provide the messaging communication of the communication nodes operating in the electronic communication environment to each of a plurality of trained specific label machine learning models.

In one implementation, S340 may function to access the messaging communications of the identified unlabeled communication nodes and provide the messaging communication in an unprocessed or minimally processed form (directly) to the trained specific labeling models as input data. S340 may additionally or alternatively access and provide messaging communications of labeled communication nodes in an unprocessed or minimally processed form (e.g., a suitable format for ingestion by the specific labeling machine learning model).

In a second implementation, S340 may function to access and analyze the messaging communications of the communication nodes to identify data elements of the messaging communication to pass to the specific labeling machine learning model. In such implementation, S340 may function to parse from the messaging communications data elements, such as key terms (e.g., terms indicative of a label), communication structures (e.g., sentence structures), reference resources or materials, one or more subject matter or topics, and the like. Accordingly, rather than passing an entire corpus of messaging communications data, S340 may function to pass only those data elements from the messaging communications that may be useful input for predicting a label at the specific labeling machine learning models.

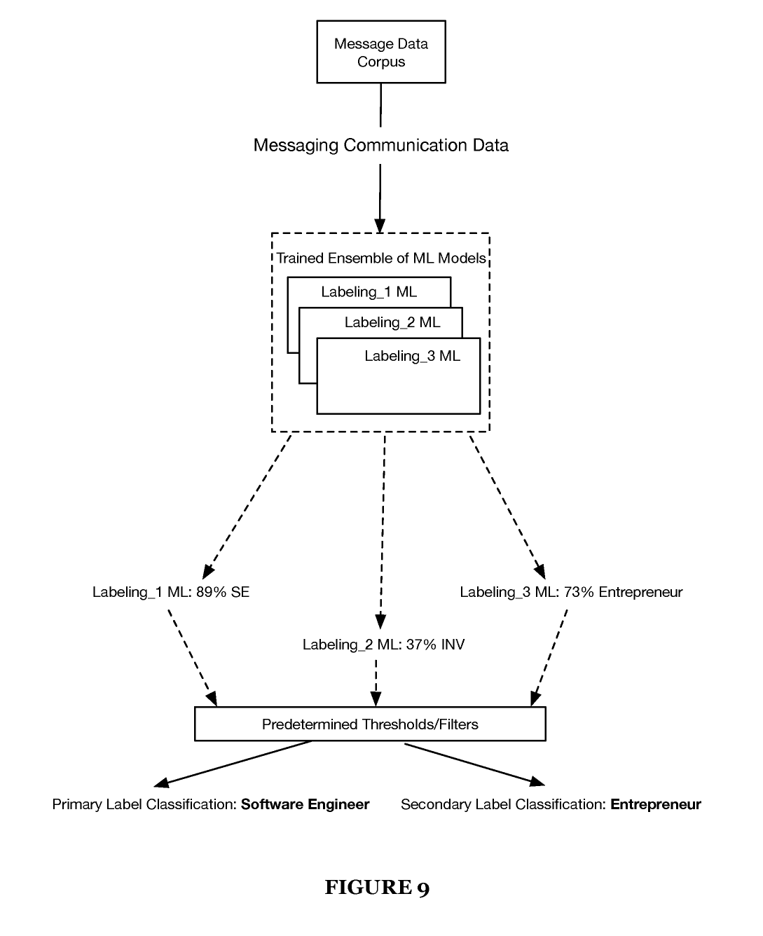

S350, which includes identifying at least one label for one or more of the communication nodes, functions to analyze the labeling outputs of each of the specific labeling machine learning models and select at least one label for a communication node, as shown in FIG. 9. In a preferred embodiment, each of the specific labeling models functions to output a label estimation or label recommendation (e.g., a labeling output) for a communication node. In such embodiment, S350 may function to review each of the labeling outputs and select the labels that satisfy a predetermined selection criteria. In some embodiments, a system implementing S350 may be configured using a predetermined selection criteria that causes the system to select a labeling out having a highest confidence level (e.g., 89%, 37%, 73%; select: label with 89% confidence). In some embodiments, a system implementing S350 may be configured according to a predetermined selection criteria that causes the system to select labeling outs satisfying a predetermined selection threshold. For example, each of three disparate specific labeling machine learning models may each output an estimation of a label for a communication node (e.g., sp-m-1: 89% SE, sp-m-2: 37% INV, sp-m-3: 73% ENT). In such embodiment, the predetermined selection criteria may comprise a predetermined selection threshold of 70%, for example. In such example, the labeling outputs sp-m-1: 89% SE (software engineer) and sp-m-3: 73% ENT (entrepreneur) may be selected by the system because the confidence level (or probability) associated with each labeling output exceeds (or meets) the predetermined selection threshold of 70%.

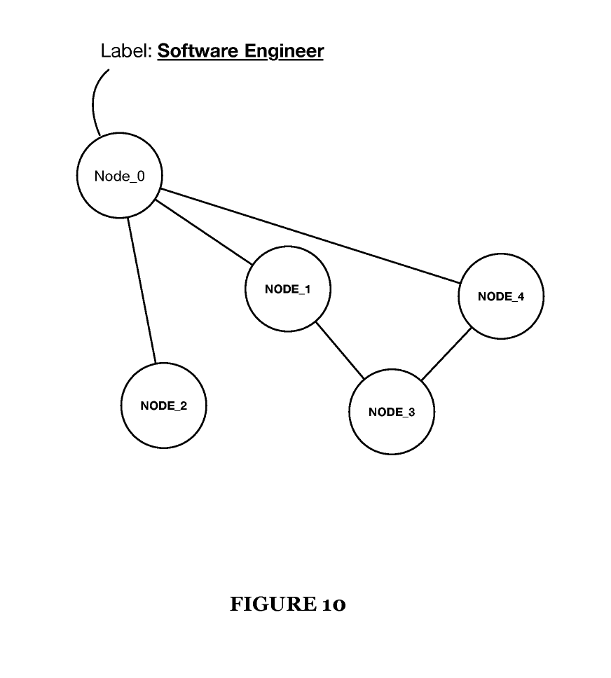

Optionally, S355, which includes implementing the selected label outputs of the communication node via one or more network mappings associated with the communication node, functions to identify the selected label outputs for the communication node within one or more network mappings, as shown in FIG. 10. The one or more network mappings may illustrate connections that may exist between a plurality of communications nodes. In a preferred embodiment, a network mapping may be defined by member communication nodes of an identified cohort group. In such embodiment, the network mapping of the cohort group functions to illustrate communication paths or various meaningful connections between each of the communication nodes of the cohort group in a format of a mapping with the nodes networked together.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the claims.

What is claimed is:

1. An online system that enables intelligent online user archetype classification within an electronic communications environment based on electronic communications data, the online system comprising:
an electronic communications server that accesses electronic communication data generated by at least one online user;
an electronic communication processing circuit that processes the electronic communication data by:
(i) extracting archetype data features from the electronic communication data;
(ii) allowing the extracted archetype data features, as input, into a machine learning classification system;
(iii) identifying, by the machine learning classification system, at least one archetype classification that relates to at least one distinct online user archetype of a plurality of distinct online user archetypes;
wherein the electronic communications server:
generates an archetype network mapping comprising a plurality of online users each having one or more associated archetype classification labels and that illustrates network connections between each of the plurality of online users;
updates the archetype network mapping to associate the at least one archetype classification to the at least one online user.

2. The system according to claim 1, wherein
the archetype classification relates to a predetermined model that represents a type of online user and/or communication node operating in an electronic communication environment.

3. The system according to claim 1, wherein
the electronic communication processing circuit implements an archetype feature extractor comprising one or more of a deep machine learning model and an archetype data feature filter that operate to assess the electronic communication data of the at least one user and produce a feature corpus comprising the archetype data features.

4. The system according to claim 1, wherein
the machine learning classification system comprises an ensemble of machine learning classifiers comprising a plurality of distinct machine learning classifiers, wherein each of the plurality of distinct machine learning classifiers is configured to generate a distinct archetype classification label upon a detection of a distinct archetype data feature within the extracted archetype data features,
wherein processing the electronic communication data includes:
generating by the plurality of distinct machine learning classifiers one or more archetype machine learning classification labels for the at least one online user based on one or more distinct archetype data features of the extracted archetype data features;
applying a global archetype classification threshold to the one or more archetype machine learning classification labels;
wherein identifying the archetype classification for the at least one online user includes outputting the archetype classification that maps to the one or more archetype machine learning classification labels that satisfies or exceeds the global archetype classification threshold.

5. The system according to claim 4, wherein
the global archetype classification threshold relates to a minimum required likelihood or probability that the archetype data features indicate an associated archetype classification label or archetype classification for the at least one online user.

6. The system according to claim 1, wherein
the electronic communications server accesses the electronic communication data generated, by the at least one online user, while operating one or more online third-party service providers including one or more of online networking services and email communication services.

7. The system according to claim 1, further comprising:
deploying the archetype network mapping via an interface of an online networking environment implementing by an online networking service.

8. The system according to claim 1, wherein
each of the plurality of online users within the archetype network mapping is represented as a distinct node within a graphical representation of the archetype network mapping;
the method further comprising:
identifying an interaction of user with a node within the graphical illustration of the archetype network mapping;
in response to identifying the interaction, automatically deploying an electronic communication composition section within an interface of an online communication environment for generating and routing an electronic communication to the online user.

9. An online method that enables intelligent online user classification and archetype detection within an electronic communications environment based on electronic communications data, the online method comprising:
at an electronic communication networking service:
implementing an electronic communications server that accesses electronic communication data generated by at least one online user;
implementing an electronic communication processing circuit that processes the electronic communication data by:
(i) extracting archetype data features from the electronic communication data;
(ii) allowing the extracted archetype data features, as input, into a machine learning classification system;
(iii) identifying, by the machine learning classification system, at least one archetype classification that relates to at least one distinct online user archetype of a plurality of distinct online user archetypes;
wherein the electronic communications service:
generates an archetype network mapping comprising a plurality of online users each having one or more associated archetype classification labels and that illustrates network connections between each of the plurality of online users;
updates the archetype network mapping to associate the at least one archetype classification to the at least one online user.

10. The method according to claim 9, further comprising:
implementing a machine learning system comprising an ensemble of machine learning classifiers comprising a plurality of distinct machine learning classifiers, wherein each of the plurality of distinct machine learning classifiers is configured to generate a distinct archetype classification label upon a detection of a distinct archetype data feature,
wherein processing the electronic communication data includes:
generating by the plurality of distinct machine learning classifiers one or more archetype machine learning classification labels for the at least one online user based on one or more distinct archetype data features of the extracted archetype data features;
applying a global archetype classification threshold to the one or more archetype machine learning classification labels;
wherein identifying the archetype classification for the at least one online user includes outputting the archetype classification that maps to the one or more archetype machine learning classification labels that satisfies or exceeds the global archetype classification threshold.

11. The method according to claim 10, wherein
the global archetype classification threshold relates to a minimum required likelihood or probability that the archetype data features indicate an associated archetype classification label or archetype classification for the at least one online user.

12. The method according to claim 9, further comprising:
deploying the archetype networking mapping via an interface of an online networking service.

13. The method according to claim 9, wherein
each of the plurality of online users within the archetype network mapping is represented as a distinct node within a graphical representation of the archetype network mapping;
the method further comprising:
selecting a node within the graphical illustration of the archetype network mapping; and
responsive to the selecting the node, automatically presenting via an interface of an online networking environment one or more options for establishing an electronic communication with the at least one online user and/or routing an electronic message to the at least one online user.

14. The method according to claim 9, wherein
each of the plurality of online users within the archetype network mapping is represented as a distinct node within a graphical representation of the archetype network mapping;
the method further comprising:
identifying an interaction of user with a node within the graphical illustration of the archetype network mapping;
in response to identifying the interaction, automatically deploying an electronic communication composition section within an interface of an online communication environment for generating and routing an electronic communication to the online user.

15. The method according to claim 9, further comprising:
receiving a search query;
responsive to receiving the search query, automatically displaying the archetype network mapping via an electronic communication interface of an online electronic communication environment.

16. The method according to claim 15, wherein
the search query comprises a specific archetype classification label assignable to online users.

17. The method according to claim 9, further comprising:
receiving a search query;
responsive to receiving the search query, automatically displaying the network mapping via a networking interface of an online networking environment.

18. The method according to claim 9, wherein:
the archetype networking mapping comprises a searchable graphical illustration;
in response to receiving a search query for an archetype classification label of an online user, prominently identifying one or more nodes within the graphical illustration of the archetype network mapping that satisfy the search query, wherein the one or more nodes comprise one or more online users; and
prominently identifying the one or more nodes within the graphical illustration of the archetype network mapping includes modifying a visual appearance of the one or more nodes thereby distinguishing the one or more nodes from other nodes of the graphical illustration of the archetype network mapping.

19. The method according to claim 9, wherein
the archetype network mapping includes an electronic communication path from a user that provided the search query to an online user or node within a graphical illustration of the archetype network mapping; and
displaying the archetype network mapping includes prominently identifying the electronic communication path within the graphical illustration of the archetype network mapping; and
prominently identifying the electronic communication path within the graphical illustration of the archetype network mapping includes modifying a visual appearance of the electronic communication path thereby distinguishing the electronic communication path from other electronic communication paths of the graphical illustration of the archetype network mapping.

20. An online system that enables intelligent online user archetype classification within an email communications environment based on email communications data, the online system comprising:
an electronic communications server that accesses email communication data generated by at least one online user;
an email communication processing circuit that processes the email communication data by:
(i) extracting archetype data features from the email communication data;
(ii) allowing the extracted archetype data features, as input, into a machine learning classification system;
(iii) identifying, by the machine learning classification system, at least one archetype classification that relates to at least one distinct online user archetype of a plurality of distinct online user archetypes;
wherein the electronic communications server:
generates an archetype network mapping comprising a plurality of online users each having one or more associated archetype classification labels and that illustrates network connections between each of the plurality of online users;
updates the archetype network mapping to associate the at least one archetype classification to the at least one online user.
